(19) United States
(12) Patent Application Publication
(10) Pub. No.: US 2004/0041372 A1
(43) Pub. Date: Mar. 4, 2004

(54) Gas bag module

(75) Inventor: Matthias Helmstetter, Aschaffenburg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/631,510

(22) Filed: Jul. 31, 2003

(30) Foreign Application Priority Data
Aug. 27, 2002 (DE) 202 13 144.0
Jan. 8, 2003 (DE) 203 00 171.0

(51) Int. Cl. B60R 21/16

(52) U.S. Cl. 280/728.2

(57) ABSTRACT

A gas bag module comprises a housing (14), a gas bag (18) held in the housing (14), a gas generator (20) and a holding ring (22; 222), by means of which at least one of the gas bag (18) and the gas generator (20) is fastened to the housing (14). At least one separate fastener (30; 230) is provided, which has at least one wedge-shaped section. The holding ring (22; 222) has at least one push-in section (28; 228) for inserting the fastener (30; 230). The wedge-shaped section of the fastener (30; 230) is pushed into the push-in section (28; 228) to be wedged therein.

### TECHNICAL FIELD

The invention relates to a gas bag module for a vehicle occupant restraint system.

### BACKGROUND OF THE INVENTION

A typical gas bag module comprises a housing, a gas bag held in the housing, a gas generator and a holding ring.

To fasten a gas bag and/or a gas generator to the module housing, a so-called holding ring or retainer ring is used as standard practice, which is placed into the inflation opening of the gas generator and which is provided for example with threaded pins which project through into openings provided on the gas bag and on the housing, so that by means of a screw coupling the gas bag can be securely connected with the housing. In so doing, the holding ring secures the fabric all around the inflation opening of the gas bag on the housing. The holding ring can additionally grasp a flange of the gas generator, so that the latter can also be secured on the housing by means of the holding ring.

### BRIEF SUMMARY OF THE INVENTION

It is an object of the invention to provide a secure fastening of the gas bag on the housing, which, at the same time, can be carried out quickly.

This is successfully achieved by a gas bag module comprising a housing, a gas bag held in the housing, a gas generator and a holding ring, by means of which at least one of the gas bag and the gas generator is fastened to the housing. At least one separate fastener (i.e. the fastener defines a separate part) is provided, which has at least one wedge-shaped section. The holding ring has push-in sections for inserting the fastener. The wedge-shaped section of the fastener is pushed into the push-in section to be wedged therein.

The fixing of the holding ring on the housing takes place by means of the pushed-in fastener, so that a saving of time can be achieved compared with a conventional screw connection.

The “wedge-shaped” section is to be understood as a section of the fastener with a wedge-shaped, trapezoidal or tapered cross-section viewed in longitudinal direction of the fastener.

The push-in direction of the fastener can lie substantially perpendicular or substantially parallel to an axial direction of the gas bag module.

According to a first preferred embodiment of the invention, the push-in section is formed by a curved tongue. This tongue can be produced for example by two preferably parallel slits being introduced into the holding ring and the material situated between the slits being bent out perpendicularly from the ring plane.

The fastening of the holding ring on the housing takes place in this embodiment in that the tongue projects through an opening formed in the housing and the fastener, pushed through the tongue, lies against the holding ring and against the housing, the fastener being wedged between the inner side of the tongue and the housing base.

According to a second preferred embodiment, the push-in section is formed in at least one detent pin arranged on the holding ring. The detent pin can be constructed in one piece with the holding ring. Here, the detent pin is spread open through the fastener, which fixes the holding ring on the housing and prevents an unintentional loosening of the detent connection.

The fastener is preferably a pin-shaped component which is separate from the holding ring and the housing.

It is conceivable to arrange several fasteners on one component.

The push-in section has preferably at least partially a trapezoidal, tapered or wedge-shaped cross-section, which is advantageously adapted to the cross-section of the fastener, in order to increase the wedging effect.

### BRIEF DESCRIPTION OF THE DRAWINGS

FIG. 1 shows a diagrammatic semilateral section of a gas bag module according to the invention in accordance with a first embodiment;

FIG. 2 shows the cutout designated by X of FIG. 1 in an enlarged illustration;

FIG. 3 shows a section along the line III-III of FIG. 2;

FIG. 4 shows a diagrammatic semilateral section of a gas bag module according to the invention in accordance with a second embodiment;

FIG. 5 shows the cutout designated by X of FIG. 4 in an enlarged illustration;

FIG. 6 shows a diagrammatic semilateral section of a gas bag module;

FIG. 7 shows a cutout of the assembly of gas bag holding ring and module housing of FIG. 6 in a top view;

FIG. 8 shows a section along the line VIII-VIII of FIG. 7;

FIG. 9 shows a diagrammatic semilateral section of a further gas bag module; and

FIG. 10 shows the cutout designated by X of FIG. 9 in an enlarged illustration.

### DETAILED DESCRIPTION OF PREFERRED EMBODIMENTS

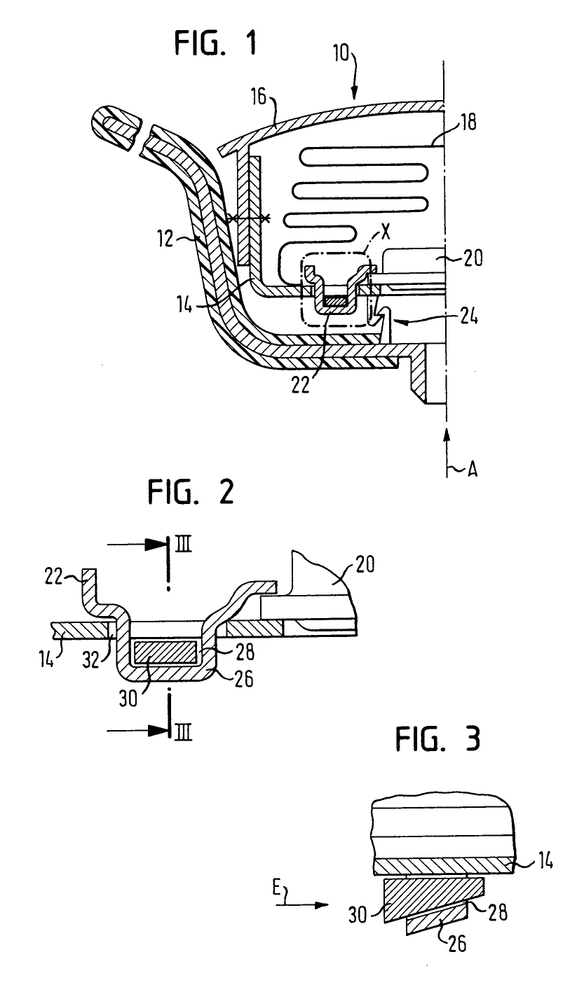

The gas bag module 10 shown in FIG. 1 according to a first embodiment of the invention, which is provided for installation in a steering wheel 12, has a module housing 14 with a covering cap 16 arranged thereon, a folded gas bag 18 arranged in the module housing 14, a gas generator 20 likewise arranged in the module housing, and a holding ring 22 fastening the gas bag 18 and the gas generator 20 on the module housing 14.

The gas bag module 10 is connected with the steering wheel 12 in a known manner, e.g. by means of a detent connection 24.

The direction A shown in the Figures corresponds to an axial direction of the gas bag module 10 and is usually conform to a direction in which the gas bag exits the module on inflation. In a steering wheel gas bag module, the direction A coincides with the axis of the steering wheel.

The holding ring 22 is placed into the gas bag, so that the gas bag 18 is clamped around the inflation opening between the holding ring 22 and the module housing 14.

The holding ring 22 has several, e.g. four, curved tongues 26 at intervals along its periphery, which are formed here by parallel notches in the holding ring 22, the ring section lying between the notches being bent outwards from the ring plane. The tongues 26 form push-in sections 28 for wedge-shaped sections of fasteners 30, the fasteners 30 forming separate parts.

The holding ring 22 is arranged so that the tongues 26 project through openings 32, provided in the module housing 14, to the exterior of the gas bag module. The wedge-shaped sections of the fasteners 30 are pushed into the push-in sections 28 so that they lie both against the inner sides of the tongues 26 and also on the base of the module housing 14.

The fasteners 30 are pushed so far into the push-in sections 28 that they are securely wedged therein. By means of this wedging effect, the holding ring 22 is fixed to the module housing 14.

In this embodiment, the push-in direction E of the fasteners 30 is perpendicular to the axial direction A of the gas bag module.

Viewed in axial direction of the fasteners 30, i.e. in the Figures in a section along the direction of arrow E, the latter have a wedge-shaped, tapered or trapezoidal cross-section. The cross-section of the tongues 26 is adapted in longitudinal direction to the cross-section of the fasteners 30, the cross-section of the tongues being also wedge-shaped, tapered or trapezoidal (see FIG. 3).

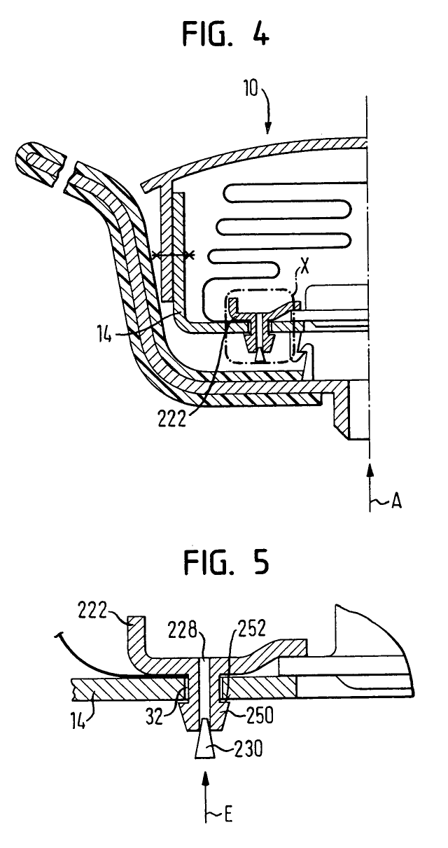

In FIGS. 4 and 5, a second embodiment is shown of a gas bag module 10 according to the invention. Here, the principle of fastening the holding ring 222 on the housing 14 is realized by the wedging of a wedge-shaped fasteners 230 in a different manner.

As can be seen in FIG. 5, several detent pins 250 are formed on the holding ring 222 in one piece therewith, e.g. four of them, which respectively have a push-in section 228 in longitudinal direction. The longitudinal direction of the detent pins 250 coincides with the axial direction A of the gas bag module, when the holding ring is inserted into the gas bag module. The detent pins 250 are provided with contact surfaces 252 which lie against the underside of the module housing 14. The fasteners 230 are pushed in after the detent pins 250 have been inserted through the openings 32 provided for this in the gas bag 18 and in the module housing 14. By the pushing in of the wedge-shaped fasteners 230 from the underside of the module, the walls of the push-in sections 228 and hence of the detent pins 250 are pressed apart and thus the detent pins 250 are secured in the openings 32 of the module housing 14 against traction in axial direction A.

In this embodiment, the push-in direction E of the fasteners is parallel to the axial direction A of the gas bag module.

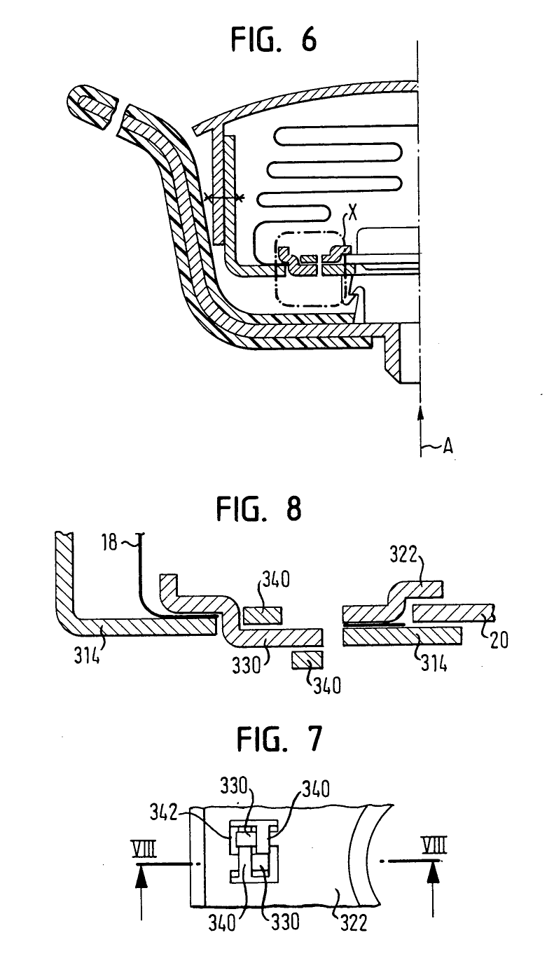

A further gas bag module is shown in FIGS. 4 to 7.

In this gas bag module, the connection between the holding ring 322 and the housing 314 is formed by an interweaving of tongues 330 arranged on the holding ring 322 and cross-pieces 340 constructed on the housing 314.

As can be seen in FIG. 7, two oppositely directed tongues 330 are formed in the holding ring 322 by the formation of an S-shaped slit 342. In the module housing 314, at the same site two cross-pieces 340, running perpendicularly to the tongues 330, are constructed, likewise by the provision of slits in the module housing 314.

Several such slit/tongue pairs 330, 340, e.g. four of them, are distributed along the periphery of the ring 322.

The tongues 330 engage through openings in the gas bag 18 and are interwoven with the cross-pieces 340.

A different geometry of tongues and cross-pieces is of course also conceivable, just as it is possible to construct the tongues, in reverse, on the housing, and the cross-pieces on the holding ring.

The advantage in such a connection lies inter alia in the small space requirement in axial direction A and also in that no additional components are required.

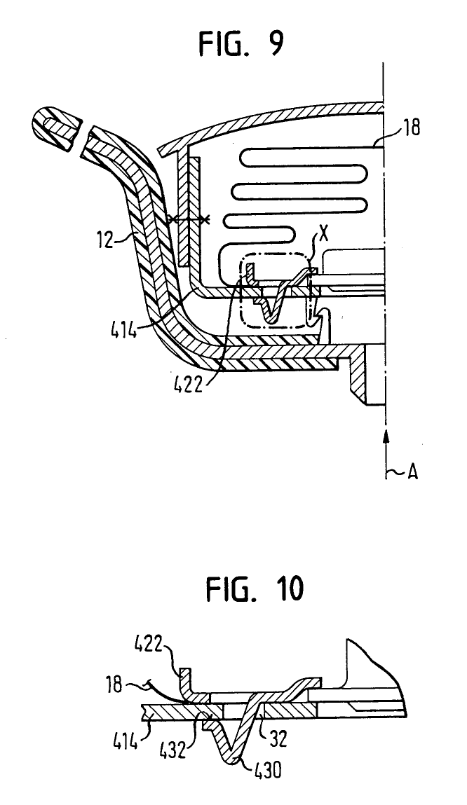

In FIGS. 9 and 10, a different type of fastening of a holding ring 422 on a module housing 414 is shown.

On the holding ring 422, several bent detent arms 430 are constructed distributed along the periphery, the extent of which in radial direction is greater than the extent of the openings 32 of the module housing 414.

The detent arms 430 have such a high elasticity that they are able to slide in one direction through the openings 32 under elastic deformation. After sliding through, detent surfaces 432 arrive in abutment against the base of the housing 414 and thus prevent a return movement of the detent arms 430. Hereby, the holding ring 422 is fixed to the module housing 414. Also in this case, the detent arms 430 extend through openings in the gas bag 18 and thus fix the gas bag 18.

The described connections can of course also be used for fastening a gas bag and/or a gas generator on a gas generator carrier.

1. A gas bag module comprising
a housing (14),
a gas bag (18) held in said housing (14),
a gas generator (20)
and a holding ring (22; 222), by means of which at least one of said gas bag (18) and said gas generator (20) is fastened to said housing (14),
characterized in that at least one separate fastener (30; 230) is provided, which has at least one wedge-shaped section,
that said holding ring (22; 222) has at least one push-in section (28; 228) for inserting said wedged-shape section of said fastener (30; 230),
said wedge-shaped section of said fasteners (30; 230) being pushed into said push-in section (28; 228) to be wedged therein.

2. The gas bag module according to claim 1, wherein said push-in direction (E) of said fastener (30) lies substantially perpendicular to an axial direction (A) of said gas bag module (10).

3. The gas bag module according to claim 1, wherein said push-in direction (E) of said fastener (230) lies substantially parallel to an axial direction (A) of said gas bag module (10).

4. The gas bag module according to claim 1, wherein said push-in section (28) is formed by a curved tongue (26).

5. The gas bag module according to claim 4, wherein said tongue (26) project through an opening (32) constructed in said housing (14).

6. The gas bag module according to claim 5, wherein said fastener (30) lies against said holding ring (22) and against said housing (14).

7. The gas bag module according to claim 1, wherein said push-in section (228) is constructed in at least one detent pin (250) arranged on said holding ring (222).

8. The gas bag module according to claim 7, wherein said detent pin (250) is constructed in one piece with said holding ring (222).

9. The gas bag module according to claim 7, wherein said detent pin (250) is spread apart by a pin-shaped fastener (230).

10. The gas bag module according to claim 1, wherein said fastener (30; 230) is a separate component from said holding ring (22; 222) and from said housing (14).

11. The gas bag module according to claim 1, wherein said push-in section (28; 228) has at least partially a trapezoidal or wedge-shaped cross-section.

12. The gas bag module according to claim 1, wherein said wedge-shaped section extends over a majority of an axial length of said fastener (30; 230).
